(19) United States
(12) Patent Application Publication
(10) Pub. No.: US 2013/0129489 A1
(43) Pub. Date: May 23, 2013

(54) TURBOCHARGER OIL FEED SYSTEM

(71) Applicants: Thomas A. SPIX, Rochester Hills, MI (US); Grant BRADY, Howell, MI (US)

(72) Inventors: Thomas A. SPIX, Rochester Hills, MI (US); Grant BRADY, Howell, MI (US)

(73) Assignee: GM GLOBAL TECHNOLOGY OPERATIONS LLC, Detroit, MI (US)

(21) Appl. No.: 13/303,738

(22) Filed: Nov. 23, 2011

(51) Int. Cl. F01D 25/18; F16L 9/00

(52) U.S. Cl. 415/175; 138/177

(57) ABSTRACT

A feed line for connecting an oil pump to a turbocharger supplies oil to the turbocharger when the oil pump is active. The feed line includes a turbo end and a pump end, which is lower than the turbo end relative to gravity. Oil drains from at least the pump end of the feed line when the oil pump is not active. The feed line has a center axis running therethrough, and a pool zone is disposed between the pump end and the turbo end of the feed line. The center axis of the feed line drops from a main line level on either side of the pool zone to a trap level in the pool zone. The pool zone therefore retains oil when the oil pump is not active.

### TECHNICAL FIELD

This disclosure relates to powertrains having oil-fed turbochargers.

### BACKGROUND

Some internal combustion engines depend on atmospheric pressure to draw in combustion air. These engines may be referred to as naturally aspirated. Another alternative is forced induction, which involves mechanically increasing the mass of intake air beyond what could be produced by atmospheric pressure alone. Generally, forced induction engines use a mechanically driven supercharger or one or more exhaust-driven turbochargers.

Turbochargers use the exhaust gases flowing from the engine to spin a turbine, which in turn spins an air pump. The air pump compresses intake air that is then used by the engine in the combustion process. The compressed intake air generally allows turbocharged engines to produce more power than naturally-aspirated engines.

### SUMMARY

A feed line for connecting an oil pump to a turbocharger is provided. The feed line supplies oil to the turbocharger when the oil pump is active. The feed line includes a turbo end and a pump end. The pump end is lower than the turbo end relative to gravity. Therefore, oil drains from at least the pump end of the feed line when the oil pump is not active. The feed line has a center axis running therethrough.

A pool zone is disposed between the pump end and the turbo end of the feed line. The center axis of the feed line drops from a main line level on either side of the pool zone to a trap level in the pool zone. The pool zone therefore retains at least some oil in the trap zone when the oil pump is not active.

The above features and advantages, and other features and advantages, of the present invention are readily apparent from the following detailed description of some of the best modes and other embodiments for carrying out the invention, as defined in the appended claims, when taken in connection with the accompanying drawings.

### BRIEF DESCRIPTION OF THE DRAWINGS

FIG. 1 is a schematic, diagrammatic view of an oil feed system for a turbocharger;

FIG. 2 is a schematic, diagrammatic view of another oil feed system for a turbocharger; and

FIG. 3 is a schematic, diagrammatic view of another oil feed system for a turbocharger.

### DETAILED DESCRIPTION

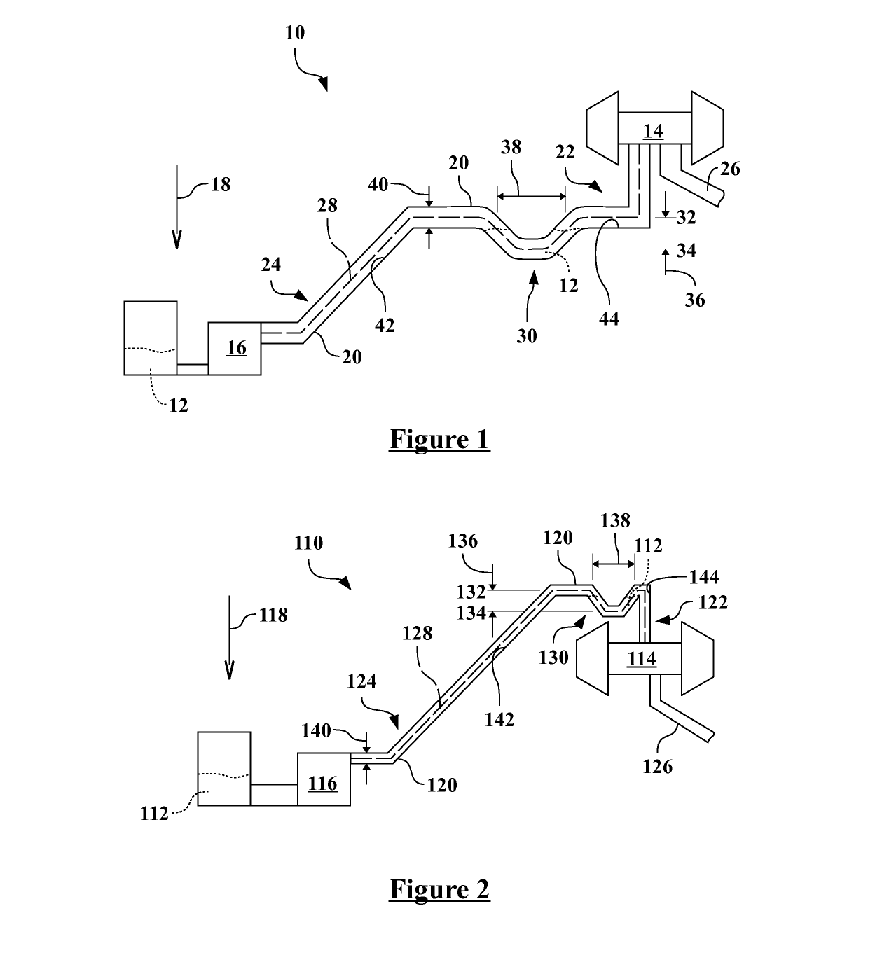

Referring to the drawings, wherein like reference numbers correspond to like or similar components whenever possible throughout the several figures, there is shown in FIG. 1 an oil feed system 10 illustrative delivery of oil 12 to a turbocharger 14 from an oil pump 16. Components shown and described in relation to one of figures may be applied to, or combined with, components shown and described in any of the other figures.

Exhaust gasses from an engine (not shown) pass through a turbine of the turbocharger 14, causing the turbine to spin. On the other end of the turbocharger 14, a compressor pumps air back to the engine. In the schematic drawing of FIG. 1, the turbine may be on either side of the turbocharger 14. A fluid bearing, journal bearing, or one or more ball bearings (not shown) may help to reduce friction created during rotation of the turbocharger 14.

As shown in FIG. 1, the oil pump 16 is below the turbocharger 14, relative to gravity 18 (schematically illustrated as a downward arrow). Note that depending upon the angle or orientation of the vehicle, gravity 18 is not always in exactly the same direction.

A feed line 20 supplies oil 12 to the turbocharger 14 when the oil pump 16 is active (i.e., when the oil pump 16 is pumping and pressurizing the oil 12 to move it through the feed line 20). The turbocharger 14 includes a return line 26, which eventually returns the oil 12 to a sump (not shown) or similar structure. The oil pump 16 may draw the oil 12 from the sump and a portion of the oil pump 16 may act as a gallery or collector before moving the oil 12 to the feed line 20.

The feed line 20 has a turbo end 22 near the turbocharger 14 and a pump end 24 near the oil pump 16. The pump end 24 is lower than the turbo end 22 relative to gravity 18. Therefore, when the oil pump 16 is not active, the oil 12 drains out from the pump end 24 of the feed line 20.

A center axis 28 is coincident with the center of the feed line 20, which may be substantially circular in cross section. The center axis 28 may be defined as running through the center of the feed line 20.

A pool zone 30 is formed, or disposed, between the pump end 24 and the turbo end 22. As shown in FIG. 1, the pool zone 30 may be formed nearer to the turbo end 22. In the pool zone 30, the center axis 28 drops from a main line level 32 on either side of the pool zone 30 down to a trap level 34 in the pool zone 30. Therefore, the pool zone 30 is configured to retain oil 12 when the oil pump 16 is not active.

When the oil pump 16 transitions from inactive to active states, there may be a lag, prime, or delay time between starting the oil pump 16 and pumping of the oil 12 from the oil pump 16 to the turbocharger 14. In some configurations, depending upon the length and characteristics of the feed line 20, the lag time may be between three to five seconds.

This lag time may be coincidental with engine start up, such that the turbocharger 14 may also be operating during the lag. The oil 12 retained by the pool zone 30 may be used to supply oil 12 for lubricating and cooling bearings (not shown) of the turbocharger 14 more-quickly than the oil pump 16.

A vertical drop 36 may be defined between the main line level 32 and the trap level 34. The size of the vertical drop 36 may be proportional to the amount (by volume or mass) of oil 12 retained in the pool zone 30. For example, the pool zone 30 may be configured such that the main line level 32 is above the trap level 34 by at least a diameter 40 of the feed line 20.

The pool zone 30 may also be defined or characterized by a horizontal span 38. The horizontal span 38 of the pool zone 30 may also be at least the diameter 40 of the feed line 20. Note that the exact amount of oil 12 retained by the pool zone 30 may vary, even from cycle to cycle, with operating conditions of the oil feed system 10 and the vehicle into which it is incorporated.

When the oil pump 16 is not active a first air pocket 42 forms between the pump end 24 and the pool zone 30 and a second air pocket 44 forms between the pool zone 30 and the turbo end 22. As the oil pump 16 begins operating, air in the first air pocket 42 is compressed and pushes the oil 12 retained in the pool zone 30 through the second air pocket 44 and into the turbocharger 14.

Referring now to FIG. 2, and with continued reference to FIG. 1, there is shown another oil feed system 110 for delivering oil 112 to a turbocharger 114 from an oil pump 116. Components shown and described in relation to FIG. 2 may be combined with components shown or described in any of the other figures.

The oil pump 116 is again below the turbocharger 114, relative to gravity 118 (generally downward, as viewed in FIG. 2). In this configuration, a feed line 120 supplies oil 112 to the top of the turbocharger 114 when the oil pump 116 is active. The turbocharger 114 includes a return line 126, which drains oil 112 from the bottom of the turbocharger 114.

The feed line 120 has a turbo end 122 near the turbocharger 114 and a pump end 124 near the oil pump 116. The pump end 124 is lower than the turbo end 122 relative to gravity 118. Therefore, when the oil pump 116 is not active, the oil 112 is likely to drain from both the pump end 124 and the turbo end 122.

A center axis 128 is coincident with the center of the feed line 120, which may be substantially circular in cross section. A pool zone 130 is formed between the pump end 124 and the turbo end 122. The pool zone 130 is again formed nearer to the turbo end 122. In the pool zone 130, the center axis 128 drops from a main line level 132 on either side of the pool zone 130 down to a trap level 134 in the pool zone 130. Therefore, the pool zone 130 is configured to retain oil 112 when the oil pump 116 is not active.

When the oil pump 116 transitions from inactive to active states, the lag time or delay between starting the oil pump 116 and pumping the oil 112 to the turbocharger 114 is reduced by the oil 112 retained in the pool zone 130. The initial oil 112 quickly provides lubrication and cooling for the turbocharger 114 more-quickly than the oil pump 116.

A vertical drop 136 may be defined between the main line level 132 and the trap level 134. The vertical drop 136 may be greater than a diameter 140 of the feed line 120.

The pool zone 130 may also be defined or characterized by a horizontal span 138. The horizontal span 138 of the pool zone 130 may also be at least the diameter 140 of the feed line 120. Note that the exact amount of oil 112 retained by the pool zone 130 may vary, even from cycle to cycle, with operating conditions of the oil feed system 110 and the vehicle into which it is incorporated.

When the oil pump 116 is not active a first air pocket 142 forms between the pump end 124 and the pool zone 130. As the oil pump 116 begins operating, air in the first air pocket 142 is compressed and pushes the oil 112 retained in the pool zone 130 through the second air pocket 144 and into the turbocharger 114.

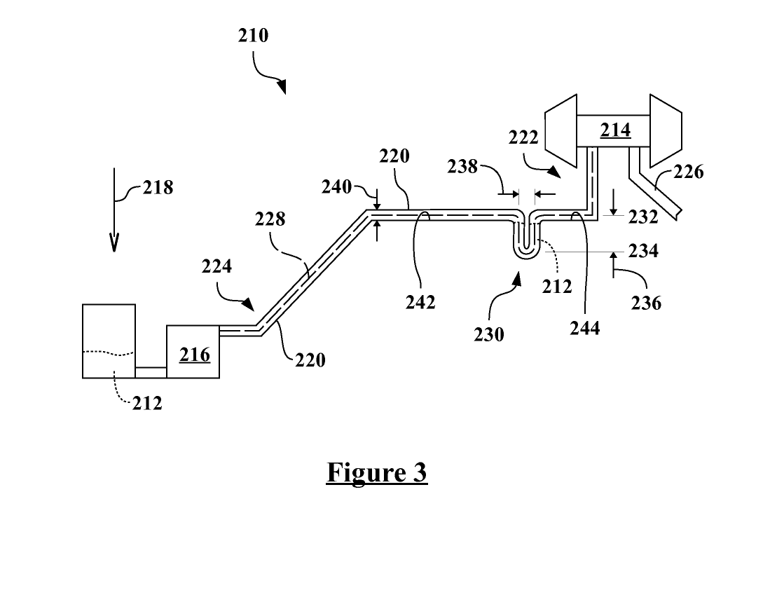

Referring now to FIG. 3, and with continued reference to FIGS. 1-2, there is shown another oil feed system 210 for delivering oil 212 to a turbocharger 214 from an oil pump 216. Components shown and described in relation to FIG. 3 may be combined with components shown or described in any of the other figures.

The oil pump 216 is again below the turbocharger 214, relative to gravity 218 (generally downward, as viewed in FIG. 3). In this configuration, a feed line 220 supplies oil 212 to the top of the turbocharger 214 when the oil pump 216 is active. The turbocharger 214 includes a return line 226, which drains oil 212 from the bottom of the turbocharger 214.

The feed line 220 has a turbo end 222 near the turbocharger 214 and a pump end 224 near the oil pump 216. The pump end 224 is lower than the turbo end 222 relative to gravity 218. Therefore, when the oil pump 216 is not active, the oil 212 is likely to out drain from at least the pump end 224.

A center axis 228 is coincident with the center of the feed line 220, which may be substantially circular in cross section. A pool zone 230 is formed between the pump end 224 and the turbo end 222. For the feed line 220, the pool zone 230 has very compact curvature.

The pool zone 230 is formed nearer to the turbo end 222. In the pool zone 230, the center axis 228 drops from a main line level 232 on either side of the pool zone 230 down to a trap level 234 in the pool zone 230. Therefore, the pool zone 230 is configured to retain oil 212 when the oil pump 216 is not active.

When the oil pump 216 transitions from inactive to active states, the lag time or delay between starting the oil pump 216 and pumping the oil 212 to the turbocharger 214 is reduced by the oil 212 retained in the pool zone 230. The initial oil 212 quickly provides lubrication and cooling for the turbocharger 214 more-quickly than the oil pump 216.

A vertical drop 236 may be defined between the main line level 232 and the trap level 234. The vertical drop 236 may be greater than a diameter 240 of the feed line 220. The pool zone 230 may also be defined or characterized by a horizontal span 238. The horizontal span 238 of the pool zone 230 may also be at least the diameter 240 of the feed line 220. In the configuration of the feed line 220 shown in FIG. 3, the vertical drop 236 is larger than that horizontal span 238.

When the oil pump 216 is not active a first air pocket 242 forms between the pump end 224 and the pool zone 230. As the oil pump 216 begins operating, air in the first air pocket 242 is compressed and pushes the oil 212 retained in the pool zone 230 through the second air pocket 244 and into the turbocharger 214. Note that the exact amount of oil 212 retained by the pool zone 230 may vary, even from cycle to cycle, with operating conditions of the oil feed system 210 and the vehicle into which it is incorporated.

The detailed description and the drawings or figures are supportive and descriptive of the invention, but the scope of the invention is defined solely by the claims. While some of the best modes and other embodiments for carrying out the claimed invention have been described in detail, various alternative designs and embodiments exist for practicing the invention defined in the appended claims.

1. A feed line connecting an oil pump to a turbocharger, wherein the feed line supplies oil to the turbocharger when the oil pump is active, the feed line comprising:
a turbo end and a pump end, wherein the pump end is lower than the turbo end, relative to gravity, such that oil drains from at least the pump end of the feed line when the oil pump is not active; and
a pool zone disposed between the pump end and the turbo end, wherein a center axis of the feed line drops from a main line level on either side of the pool zone to a trap level in the pool zone, such that the pool zone is configured to retain oil when the oil pump is not active.

2. The feed line of claim 1, wherein the main line level is above the trap level by at least a diameter of the feed line.

3. The feed line of claim 2, wherein a first air pocket forms between the pump end and the pool zone when the oil pump is not active.

4. The feed line of claim 3, wherein the pool zone has horizontal span of at least the diameter of the feed line.

5. The feed line of claim 4, wherein a second air pocket forms between the pool zone and the turbo end when the oil pump is not active.

6. An oil feed system, comprising:
a turbocharger;
an oil pump; and
a feed line connecting the oil pump to the turbocharger, wherein the feed line supplies oil to the turbocharger when the oil pump is active, the feed line includes:
a turbo end and a pump end, wherein the pump end is lower than the turbo end, relative to gravity, such that oil drains from at least the pump end of the feed line when the oil pump is not active, and
a pool zone disposed between the pump end and the turbo end, wherein a center axis of the feed line drops from a main line level on either side of the pool zone to a trap level in the pool zone, such that the pool zone is configured to retain oil when the oil pump is not active.

7. The oil feed system of claim 6,
wherein a first air pocket forms between the pump end and the pool zone of the feed line when the oil pump is not active, and
wherein a second air pocket forms between the pool zone and the turbo end of the feed line when the oil pump is not active.

8. The oil feed system of claim 7, wherein the main line level of the feed line is above the trap level by at least a diameter of the feed line.

9. The oil feed system of claim 8, wherein the pool zone of the feed line has horizontal span of at least the diameter of the feed line.
